(19) United States
(12) Patent Application Publication
(10) Pub. No.: US 2026/0316285 A1
(43) Pub. Date: Oct. 15, 2026

(54) HAND-EYE CALIBRATION FOR A ROBOTIC MANIPULATOR

(71) Applicant: Ocado Innovation Limited, Hatfield (GB)

(72) Inventor: Sirapoab CHAIKUNSAENG, Leeds (GB)

(21) Appl. No.: 19/108,563

(22) PCT Filed: Sep. 1, 2023
(86) PCT No.: PCT/EP2023/074094

§ 371 Date: Mar. 4, 2025

(30) Foreign Application Priority Data
Sep. 6, 2022 (GB) 2212987.8

(51) Int. Cl. B25J 9/16; B25J 19/02; G06T 7/38; G06T 7/73; G06T 7/80

(52) U.S. Cl. CPC B25J 9/1692; B25J 9/1697; B25J 19/023; G06T 7/38; G06T 7/73; G06T 7/80; G06T 2207/10028; G06T 2207/30204

(57) ABSTRACT

A method of calibrating a camera mounted on a robotic manipulator comprising an end effector. The method involves obtaining a plurality of images of a single calibration object installed at a location in a workspace of the robotic manipulator, wherein the images are captured by the camera at different respective configurations of the robotic manipulator. The images are processed to obtain respective first object positions of the calibration object relative to the camera. Respective second object positions of the calibration object relative to the end effector are obtained based on a determined location of the calibration object relative to the robotic manipulator. The method further comprises performing point-cloud registration based on a first point cloud comprising the first object positions and a second point cloud comprising the second object positions to determine a hand-eye transformation. A robotic manipulator controller configured to perform the calibration method is also provided, along with a system including the robotic manipulator, controller and single calibration object installed in the workspace of the robotic manipulator.

### TECHNICAL FIELD

The present disclosure relates to robotic manipulators, specifically systems and methods for calibrating a vision system of a robotic manipulator.

### BACKGROUND

Hand-eye coordination (or “eye-hand coordination”) involves the ability to control movement of the hands by coordinating the information received via the eyes, i.e. the human vision system. Everyday human tasks involving reaching and grasping objects, e.g. picking up a cup from a table, rely on the hands and eyes collaborating in the same coordinate system.

Thus, hand-eye calibration is a core problem in robotic manipulation where robots interact with objects in their surroundings, e.g. grasping an object and placing it in another location. The goal is to have a robotic system where the machine vision system, using a camera, can detect an object for grasping and the robot can direct its “hand”, i.e. an end effector, to the object. The object coordinates are detected in the coordinate system of the camera and so need to be transformed to the coordinate system of the robot for the motion system of the robot to direct the end effector accordingly. Hand-eye coordination for robotic manipulation systems thus relies on an accurate transformation, e.g. represented as a transformation matrix, between the camera (“eye”) coordinate system and the end effector (“hand”) coordinate system. Hand-eye calibration for a robotic manipulator thus involves determining the transformation between the camera and end effector coordinate systems.

There are issues with current systems, however, including only being capable of calibrating the colour, e.g. RGB, sensor of the camera and being data-expensive. For example, current hand-eye camera calibration solutions are typically done via mathematical optimization without a closed-form solution, which introduces three main issues. Firstly, these solutions require significantly more data points to accurately calibrate the camera, which then means that the robot needs to spend a long time moving between multiple waypoints to gather enough information to calibrate accurately. In practice, a given robot manipulator also may not be able to reach some of the required waypoints, and having more waypoints also increases the time required to calibrate the robot. Secondly, optimization-based methods inherently involve an advanced understanding of the mathematical field of optimization, which limits the number of developers capable of maintaining the repository in practice. Thirdly, optimization-based methods generally demand a large codebase to be developed, meaning that the package itself would require multiple dependencies, unit tests to be written, and more DevOps effort to deploy and guarantee its performance.

There is, therefore, an objective for a simpler calibration process for a robotic manipulator which reduces the time and data/compute requirements involved.

### SUMMARY

Accordingly, there is provided a method of calibrating a camera mounted on a robotic manipulator comprising an end effector, the method comprising: obtaining a plurality of images of a single calibration object installed at a location in a workspace of the robotic manipulator, wherein the images are captured by the camera at different respective configurations of the robotic manipulator; processing the images to obtain respective first object positions of the calibration object relative to the camera; obtaining respective second object positions of the calibration object relative to the end effector based on a determined location of the calibration object relative to the robotic manipulator; and performing point-cloud registration based on a first point cloud comprising the first object positions and a second point cloud comprising the second object positions to determine a hand-eye transformation.

Optionally, obtaining the respective second object positions comprises: positioning the end effector at the location of the calibration object in the workspace to determine a third object position relative to the robotic manipulator; and determining the second object positions based on the third object position and respective robot-hand transformations corresponding to the respective configurations of the robotic manipulator.

Optionally, the plurality of images comprises a set of at least four images.

Optionally, processing the images involves performing at least one of line detection, rectangle detection, or object detection to detect the calibration object in each of the images.

Optionally, processing the images involves performing position estimation based on the detected calibration object in each of the images to determine the respective first object positions.

Optionally, the single calibration object is installed at an unknown orientation in the workspace.

Optionally, performing the point-cloud registration comprises assigning to each of the first object positions a corresponding independent feature vector. Optionally, performing the point-cloud registration comprises performing point-cloud registration based on feature matching using the independent feature vectors.

Optionally, the calibration object comprises a fiducial marker. Optionally, the fiducial marker comprises one of an: ARTag, AprilTag, ArUco or STag marker.

Optionally, the first and second object positions comprise respective positions of a centre-point of the calibration object.

Optionally, the method involves storing the hand-eye transformation for transforming coordinates of a detected object in a first coordinate system of the camera to a second coordinate system of the robotic manipulator or end effector.

Optionally, the method involves: obtaining and processing an image of the single calibration object, captured by a static camera in the workspace, to determine a first pose of the calibration object relative to the static camera; determining a second pose of the calibration object in a reference frame of the robotic manipulator based on another image of the single calibration object, captured by the camera mounted on the robotic manipulator, and the hand-eye transformation; and determining a pose of the static camera, in the reference frame of the robotic manipulator, based on the first and second poses of the calibration object.

In a related aspect, there is provided a computer program comprising instructions which, when the program is executed by a computer, cause the computer to carry out the provided method. In a further related aspect, there is provided a computer-readable data carrier having stored thereon the computer program.

In a related aspect, there is provided a controller for a robotic manipulator, wherein the controller is configured to perform the provided method.

In another aspect, there is provided a system comprising: a robotic manipulator having an end effector and a mounted camera; a single calibration object installed at a location in a workspace of the robotic manipulator; and a controller configured to: obtain and process a plurality of images of the single calibration object, captured by the mounted camera at different respective configurations of the robotic manipulator, to obtain respective first object positions of the calibration object relative to the camera; obtain respective second object positions of the calibration object relative to the end effector based on a determined location of the calibration object relative to the robotic manipulator; and perform point-cloud registration based on a first point cloud comprising the first object positions and a second point cloud comprising the second object positions to determine a hand-eye transformation.

Optionally, the system comprises a static camera positioned in the workspace, wherein the controller is configured to: obtain and process an image of the single calibration object, captured by the static camera, to determine a first pose of the calibration object relative to the static camera; determine a second pose of the calibration object in a reference frame of the robotic manipulator based on another image of the single calibration object, captured by the mounted camera, and the hand-eye transformation; and determine a pose of the static camera, in the reference frame of the robotic manipulator, based on the first and second poses of the calibration object.

In general terms, this description introduces systems and methods to calibrate a robot-mounted camera by determining a single known point relative to the robot coordinate system, e.g. the base frame of reference, and imaging the known point (using a calibration object) at a series of unique configurations. The set of detections of the known point in the camera frame of reference, determined from the captured images, are registered to match in position with the corresponding point set in the end effector frame of reference to determine the hand-eye transformation between the camera and end effector frames. The point set in the end effector frame is determined by applying a respective transform, based on forward kinematics of the robot at each respective configuration, to the known point in the base frame. The calibration is thus solved in closed form, meaning that the solution is global, and no initialization is required. Once determined, the hand-eye transformation can be stored to apply to further points in the camera frame corresponding to objects detected using a machine vision system incorporating the robot-mounted camera. Thus, the camera is calibrated to the robot so that manipulation tasks can be performed.

Compared to known methods, the present calibration process reduces the number of data points needed to perform the calculations, which inherently reduces the number of captured images (and corresponding robot waypoints) needed during the calibration process. Thus, the time and data/compute requirements for the present calibration process are reduced compared to known solutions.

### BRIEF DESCRIPTION OF THE DRAWINGS

Embodiments will now be described by way of example only with reference to the accompanying drawings, in which like reference numbers designate the same or corresponding parts, and in which:

FIG. 1 is a schematic diagram of a robotic system according to an embodiment;

FIG. 2 is a schematic front view of a robotic manipulator set up for calibration according to an embodiment;

FIGS. 3A and 3B are schematic illustrations of the calibration process according to an embodiment; and

FIG. 4 shows a flowchart depicting a method of calibrating a camera mounted on a robotic manipulator according to an embodiment.

In the drawings, like features are denoted by like reference signs where appropriate.

### DETAILED DESCRIPTION

In the following description, some specific details are included in the following description to provide a thorough understanding of various disclosed embodiments. However, one skilled in the relevant art will recognise that embodiments may be practised without one or more of these specific details or with other methods, components, materials, etc. In some instances, well-known structures associated with gripper assemblies and/or robotic manipulators (such as processors, sensors, storage devices, network interfaces, workpieces, tensile members, fasteners, electrical connectors, mixers, and the like) are not shown or described in detail to avoid unnecessarily obscuring descriptions of the disclosed embodiments.

Unless the context requires otherwise, the word “comprise” and its variants like “comprises” and “comprising” are to be construed in this description and appended claims in an open, inclusive sense, i.e. as “including, but not limited to”.

Reference throughout this specification to “one”, “an”, or “another” applied to “embodiment” or “example”, means that a particular referent feature, structure, or characteristic described in connection with the embodiment, example, or implementation is included in at least one embodiment, example, or implementation. Thus, the appearances of the phrase “in one embodiment” or the like in various places throughout this specification do not necessarily refer to the same embodiment. Furthermore, the particular features, structures, or characteristics may be combined in any suitable manner in one or more embodiments, examples, or implementations.

It should be noted that, as used in this specification and the appended claims, the used forms “a”, “an”, and “the” include plural referents unless the content clearly dictates otherwise. It should also be noted that the term “or” is generally employed in its sense including “and/or” unless the content clearly dictates otherwise.

With regard to transformations, the terms “frame of reference” and “coordinate system” are used interchangeably throughout this description. Mathematically, a given coordinate system is the set of numbers used to map the space points within a corresponding reference frame.

The term “pose” used throughout this specification represents the position and orientation of a given object in space. For example, a six-dimensional (6D) pose of the object includes respective values in three translational dimensions (e.g. corresponding to a position) and three rotational dimensions (e.g. corresponding to an orientation) of the object.

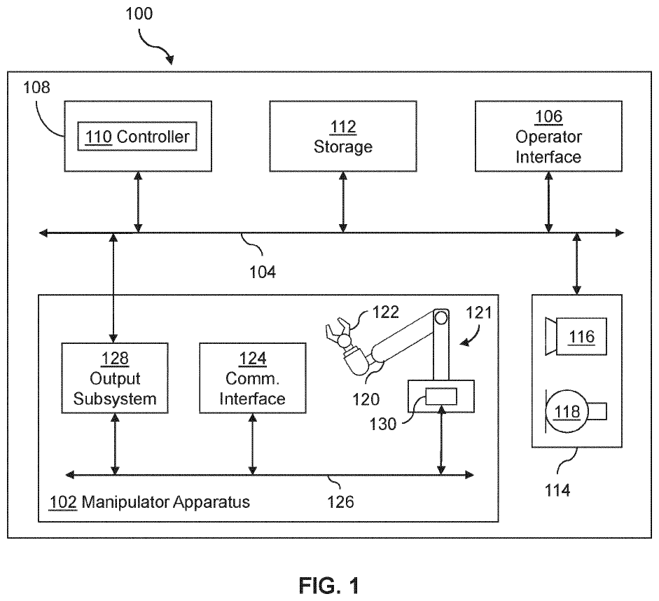

Regarding FIG. 1, there is illustrated an example of a robotic system 100, e.g. a robotic manipulation system, that may be adapted for use with the present assemblies, devices, and methods. The robotic system 100 may form part of an online retail operation, such as an online grocery retail operation. Still, it may also be applied to any other operation requiring the manipulation of items. For example, the robotic system 100 may also be adapted for picking or sorting articles, e.g. as a robotic picking/packing system sometimes referred to as a “pick and place robot”.

The robotic system 100 includes a manipulator apparatus 102 comprising a robotic manipulator 121. The manipulator 121 is an electro-mechanical machine comprising one or more appendages, such as a robotic arm 120, and an end effector 122 mounted on an end of the robotic arm 120. The end effector 122 is a device configured to interact with the environment in order to perform tasks, including, for example, gripping, grasping, releasably engaging or otherwise interacting with an item. Examples of the end effector 122 include a jaw gripper, a finger gripper, a magnetic or electromagnetic gripper, a Bernoulli gripper, a vacuum suction cup, an electrostatic gripper, a van der Waals gripper, a capillary gripper, a cryogenic gripper, an ultrasonic gripper, and a laser gripper.

The robotic manipulator 121 can grasp and manipulate an object. In the case of a pick and place application, the robotic manipulator 121 is configured to pick an item from a first location and place the item in a second location, for example.

The manipulator apparatus 102 is communicatively coupled via a communication interface 104 to other components of the robotic system 100, e.g. one or more optional operator interfaces 106 from which an observer may observe or monitor system 100 and the manipulator apparatus 102. The operator interfaces 106 may include a WIMP interface and an output display of explanatory text or a dynamic representation of the manipulator apparatus 102 in a context or scenario. For example, the dynamic representation of the manipulator apparatus 102 may include a video feed, for instance, a computer-generated animation. Examples of suitable communication interface 104 include a wire-based network or communication interface, an optical-based network or communication interface, a wireless network or communication interface, or a combination of wired, optical, and/or wireless networks or communication interfaces.

The example robotic system 100 also includes a control system 108, including at least one controller 110 communicatively coupled to the manipulator apparatus 102 and any other components of the robotic system 100 via the communication interface 104. The controller 110 comprises a control unit or computational device having one or more electronic processors. Embedded within the one or more processors is computer software comprising a set of control instructions provided as processor-executable data that, when executed, cause the controller 110 to issue actuation commands or control signals to the manipulator system 102. For example, the actuation commands or control signals cause the manipulator 121 to carry out various methods and actions, such as identifying and manipulating items.

The one or more electronic processors may include at least one logic processing unit, such as one or more microprocessors, central processing units (CPUs), digital signal processors (DSPs), graphics processing units (GPUs), application-specific integrated circuits (ASICs), programmable gate arrays (PGAs), programmed logic units (PLUS), or the like. In some implementations, the controller 110 is a smaller processor-based device like a mobile phone, single-board computer, embedded computer, or the like, which may be termed or referred to interchangeably as a computer, server, or analyser. The set of control instructions may also be provided as processor-executable data associated with the operation of the system 100 and manipulator apparatus 102 included in a non-transitory computer-readable storage device 112, which forms part of the robotic system 100 and is accessible to the controller 110 via the communication interface 104.

In some implementations, the storage device 112 includes two or more distinct devices. The storage device 112 can, for example, include one or more volatile storage devices, e.g. random access memory (RAM), and one or more non-volatile storage devices, e.g. read-only memory (ROM), flash memory, magnetic hard disk (HDD), optical disk, solid-state disk (SSD), or the like. A person of skill in the art will appreciate storage may be implemented in a variety of ways such as a read-only memory (ROM), random access memory (RAM), hard disk drive (HDD), network drive, flash memory, digital versatile disk (DVD), any other forms of computer- and processor-readable memory or storage medium, and/or a combination thereof. Storage can be read-only or read-write as needed.

The robotic system 100 includes a sensor subsystem 114 comprising one or more sensors that detect, sense or measure conditions or states of the manipulator apparatus 102 and/or conditions in the environment or workspace in which the manipulator 121 operates and produce or provide corresponding sensor data or information. Sensor information includes environmental sensor information, representative of environmental conditions within the workspace of the manipulator 121, as well as information representative of condition or state of the manipulator apparatus 102, including the various subsystems and components thereof, and characteristics of the item to be manipulated. The acquired data may be transmitted via the communication interface 104 to the controller 110 for directing the manipulator 121 accordingly. Such information can, for example, include diagnostic sensor information that is useful in diagnosing a condition or state of the manipulator apparatus 102 or the environment in which the manipulator 121 operates.

Such sensors include, for example, one or more cameras or imagers 116 (e.g. responsive within visible and/or non-visible ranges of the electromagnetic spectrum including, for instance, infrared and ultraviolet). The one or more cameras 116 may include a depth camera, e.g. a stereo camera, to capture depth data alongside colour channel data in an imaged scene. Other sensors of the sensor subsystem 114 may include one or more of: contact sensors, force sensors, strain gages, vibration sensors, position sensors, attitude sensors, accelerometers, radars, sonars, lidars, touch sensors, pressure sensors, load cells, microphones 118, meteorological sensors, chemical sensors, or the like. In some implementations, the sensors include diagnostic sensors to monitor a condition and/or health of an on-board power source within the manipulator apparatus 102 (e.g. a battery array, ultra-capacitor array, or fuel cell array).

In some implementations, the one or more sensors comprise receivers to receive position and/or orientation information concerning the manipulator 121. For example, a global position system (GPS) receiver to receive GPS data, two more time signals for the controller 110 to create a position measurement based on data in the signals, such as time-of-flight, signal strength, or other data to effect a position measurement. Also, for example, one or more accelerometers, which may also form part of the manipulator apparatus 102, could be provided on the manipulator 121 to acquire inertial or directional data, in one, two, or three axes, regarding the movement thereof.

The robotic manipulator 121 of the system 100 may be piloted by a human operator at the operator interface 106. In a human operator-controlled (or “piloted”) mode, the human operator observes representations of sensor data, e.g. video, audio, or haptic data received from the one or more sensors of the sensor subsystem 114. The human operator then acts, conditioned by a perception of the representation of the data, and creates information or executable control instructions to direct the manipulator 121 accordingly. In the piloted mode, the manipulator apparatus 102 may execute control instructions in real-time (e.g. without added delay) as received from the operator interface 106 without taking into account other control instructions based on the sensed information.

In some implementations, the manipulator apparatus 102 operates autonomously, i.e. without a human operator creating control instructions at the operator interface 106 for directing the manipulator 121. The manipulator apparatus 102 may operate in an autonomous control mode by executing autonomous control instructions. For example, the controller 110 can use sensor data from one or more sensors of the sensor subsystem 114. The sensor data is associated with operator-generated control instructions from one or more times during which the manipulator apparatus 102 was in the piloted mode to generate autonomous control instructions for subsequent use. For example, deep learning techniques can be used to extract features from the sensor data. Thus, in the autonomous mode, the manipulator apparatus 102 can autonomously recognise features or conditions of its environment and the item to be manipulated. In response, the manipulator apparatus 102 performs one or more defined acts or tasks. For example, the manipulator apparatus 102 performs a pipeline or sequence of acts or tasks.

In some implementations, the controller 110 autonomously recognises features or conditions of the environment surrounding the manipulator 121 and one or more virtual items composited into the environment. The environment is represented by sensor data from the sensor subsystem 114. In response to being presented with the representation, the controller 110 issues control signals to the manipulator apparatus 102 to perform one or more actions or tasks.

In some instances, the manipulator apparatus 102 may be controlled autonomously at a given time while being piloted, operated, or controlled by a human operator at another time. That is, the manipulator apparatus 102 may operate under the autonomous control mode and change to operate under the piloted (i.e. non-autonomous) mode. In another mode of operation, the manipulator apparatus 102 can replay or execute control instructions previously carried out in the piloted mode. That is, the manipulator apparatus 102 can operate based on replayed pilot data without sensor data.

The manipulator apparatus 102 further includes a communication interface subsystem 124 (e.g. a network interface device) communicatively coupled to a bus 126 and which provides bi-directional communication with other components of the system 100 (e.g. the controller 110) via the communication interface 104. The communication interface subsystem 124 may be any circuitry effecting bidirectional communication of processor-readable data and processor-executable instructions, such as radios (e.g. radio or microwave frequency transmitters, receivers, transceivers) ports, and/or associated controllers. Suitable communication protocols include FTP, HTTP, Web Services, SOAP with XML, cellular (e.g. GSM, CDMA), Wi-Fi® compliant, Bluetooth® compliant, and the like.

The manipulator apparatus 102 further includes a motion subsystem 130, communicatively coupled to the robotic arm 120 and end effector 122. The motion subsystem 130 comprises one or more motors, solenoids, other actuators, linkages, drive-belts, or the like operable to cause the robotic arm 120 and/or end effector 122 to move within a range of motions in accordance with the actuation commands or control signals issued by the controller 110. The motion subsystem 130 is communicatively coupled to the controller 110 via the bus 126.

The manipulator apparatus 102 also includes an output subsystem 128 comprising one or more output devices, such as speakers, lights, or displays that enable the manipulator apparatus 102 to send signals into the workspace to communicate with, for example, an operator and/or another manipulator apparatus 102.

A person of ordinary skill in the art will appreciate the components in the manipulator apparatus 102 may be varied, combined, split, omitted, or the like. In some examples, one or more of the communication interface subsystem 124, the output subsystem 128, and the motion subsystem 130 are combined. In other instances, one or more subsystems (e.g. the motion subsystem 130) are split into further subsystems.

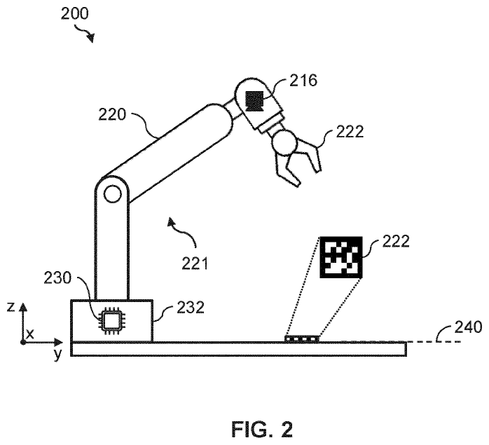

FIG. 2 shows an example setup for calibrating a robotic system 200 including a robotic manipulator 221 (e.g. an implementation of the robotic manipulator 121 described in previous examples). In accordance with such examples, the robotic manipulator 221 includes a robotic arm 220, an end effector 222, and a motion subsystem 230. The motion subsystem 230 is communicatively coupled to the robotic arm 220 and end effector 222 and configured to cause the robotic arm 220 and/or end effector 222 to move in accordance with actuation commands or control signals issued by a controller (not shown). The controller, e.g. controller 110 described in previous examples, is part of a manipulator apparatus with the robotic manipulator 221.

The robotic manipulator 221, once calibrated, may be arranged to manipulate an object, e.g. to grasp the object with the end effector 222, in the workspace. For example, the robotic system 200 may be implemented in an automated storage and retrieval system (ASRS), e.g.

in a picking station thereof. An ASRS typically includes multiple containers arranged to store items and one or more load-handling device or automated guided vehicle (AGV) to retrieve one or more containers during fulfilment of a customer order. At a picking station, items are picked from and/or placed into the one or more retrieved containers. Further discussion on implementing a robotic manipulator 221, calibrated in accordance with the present disclosure, in an ASRS is provided further below.

The robotic system 200 of FIG. 2 includes a camera 216 mounted on the robotic manipulator 221. For example, the camera 216 is mounted on a link 220 or joint of the robotic manipulator 221 such as at the wrist thereof as shown in FIG. 2. The camera 216 is arranged to capture images of the workspace of the robotic manipulator 221. For example, the camera 216 is arranged such that it has a view of the workspace of the robotic manipulator 221 at different configurations, e.g. poses, in its environment. In examples, the camera 216 has a view of an object when grasped by the end effector 222 or other objects in the vicinity of the end effector 222 within the workspace. The camera 216 may correspond to the one or more cameras or imagers 116 in the sensor subsystem 114 of the robotic system 100 described with reference to FIG. 1.

In examples, the camera 216 of the robotic system 200 comprises a depth camera configured to capture depth images. For example, a depth image (or “depth map”) includes depth information of the scene viewed by the camera 216 along with intensity values for each pixel. In some cases, a point cloud generator may be associated with the camera 216, e.g. depth camera, mounted to view the workspace of the robot 221. Examples of structured light devices for use in point cloud generation include RealSense™ devices by Intel®, Kinect™ devices by Microsoft®, time of flight devices, ultrasound devices, stereo camera pairs and laser stripers. These devices typically generate depth map images.

In the art, it is usual to calibrate depth map images for aberrations in the lenses and sensors of the camera, e.g. to align the colour and depth channels. In some cases, a user interface (UI) for the camera can be used to visually check that the colour and depth data correctly aligns. If they do not, i.e. the overlap between the colour image and depth cloud is not sufficiently accurate, the camera can be intrinsically (re-) calibrated. Once the camera is intrinsically calibrated, the depth map can be transformed into a set of metric 3D points, i.e. a point cloud. Thus, the image data obtained from the camera 216 may comprise, or be associated with, corresponding point clouds. Preferably, each point cloud is an organised point cloud which means that each three-dimensional point lies on a line of sight of a distinct pixel resulting in a one-to-one correspondence between 3D points and pixels. Organisation is preferable because it allows for more efficient point cloud processing. For simplicity, the camera 116, 216 is shown as a single unit in the Figures. However, as will be appreciated, each of the functions of depth map generating and depth map calibration could be performed by separate units, for example, the depth map calibration means could be integrated in the controller of the robotic system 100, 200.

A controller for the robotic manipulator 221, e.g. the controller 100 communicatively coupled to the manipulator apparatus of previous examples, is configured to obtain the images captured by the camera 216. The controller processes the images in accordance with the present calibration method set out below in steps.

The calibration setup also includes a single calibration object 242 installed at a location in the workspace of the robotic manipulator 221. For example, the calibration object 242 is a fiducial marker, as shown in FIG. 2. The fiducial marker might be one of an ARTag, AprilTag, ArUco or STag marker, for example. The calibration object 242 may be installed on a common surface 240 on which the robotic manipulator 221, e.g. the base 232 thereof, is supported, as shown in the example of FIG. 2.

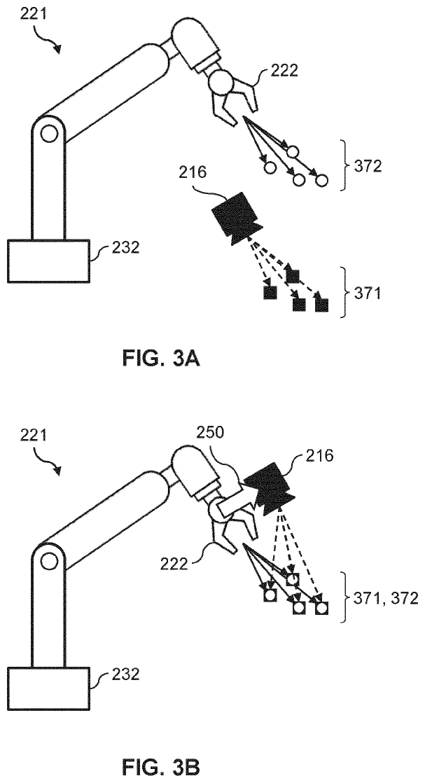

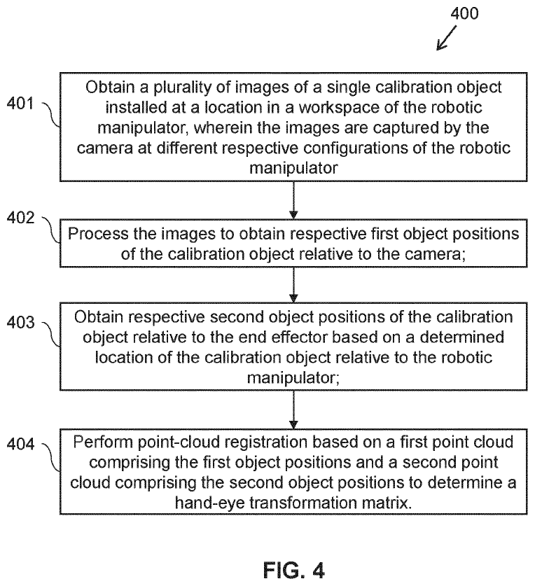

FIG. 4 shows a method 400 of calibrating a camera mounted on a robotic manipulator comprising an end effector, with a part of the method illustrated schematically in FIGS. 3A and 3B. The robotic manipulator (or simply “robot”) may be one of the example robotic manipulators 121, 221 described with reference to FIGS. 1 and 2. In examples, the method 400 is computer-implemented, for example performed by one or more components of the robotic system 100 previously described, e.g. the control system 108 or controller 110.

The method 400 involves obtaining 401 a plurality of images of a single calibration object installed at a location in the workspace of the robotic manipulator. The images are captured by the camera 216 at different respective configurations of the robotic manipulator 221. For example, the controller 110 controls the robotic manipulator 221, via the motion subsystem 230, to position itself in a series of different configurations, e.g. with its respective joints, links, etc. at different poses (positions and orientations) in the workspace. Such different poses may be considered a series of waypoints which the controller 110 positions the robotic manipulator 221 in as part of the calibration process. For example, the controller may obtain configuration data or waypoint data representative of the series of configurations/waypoints in the frame of reference of the robotic manipulator 221, e.g. relative to its base 232. The controller then issues actuation commands or control signals to the motion subsystem 230 to cause the robotic arm 220 and/or end effector 222 to move, translationally and/or rotationally, to each configuration/waypoint represented in the configuration/waypoint data.

At each configuration (or waypoint) of the robotic manipulator 221, the camera 216 captures an image of the calibration object 242 in the workspace. As mentioned in the description of the setup, the calibration object 242 may be a fiducial marker, as shown in FIG. 2. For example, the fiducial marker might be one of an ARTag, AprilTag, ArUco or STag marker. Compared to known calibration methods, the ability to use a single calibration object, e.g. fiducial marker, in the present method 400 simplifies the process of calibration, for example when compared to methods involving multiple calibration objects and corresponding waypoints for the robotic manipulator.

The captured images are processed 402 to obtain respective first object positions of the calibration object 242 relative to the camera 216. In some examples, processing 402 the images involves performing computer vision techniques to detect and locate the calibration object. For example, where the calibration object is a two-dimensional barcode “tag” fiducial marker, a sequence of line detection and rectangle or quad detection may be used to detect the tag in the images. Such computer vision techniques may be employed by a detector system designed for a particular type or version of the calibration object used, for example. In such examples, a size of the calibration object, e.g. tag, may be inputted to the detector for determining its pose in the scene.

In certain examples, processing 402 the images involves performing object detection to detect the calibration object in each of the images. For example, an object detection model (e.g. neural network) may be trained to detect whether a given type of calibration object is present in a given image. Processing the images may, additionally or alternatively, involve performing position estimation based on the detected calibration object in each of the images to determine the respective first object positions. In examples in which a trained neural network model is employed to detect the calibration object, the neural network model may also be configured to determine a pose of the calibration object in the images.

In examples, the images captured by the camera 216 are depth images or point clouds containing intensity/colour information and position information for each pixel location, e.g. three position values and one or more colour values. For example, each depth image or point cloud captured by the camera 216 comprises values for six parameters [r, g, b, x, y, z] where r, g, b are the colour channel values (for red, green and blue in this case) and x, y, z are the cartesian position values for a given pixel. When processing 402 the images to detect the calibration object 242, in some examples, only the colour channel values for the pixels are processed to determine a pixelwise location of the calibration object in the image. For example, the [r, g, b] image is processed using computer vision techniques and/or a trained neural network to determine the pixelwise location of the calibration object 242 in the image. The cartesian position of the calibration object 242 in the workspace, relative to the camera 216, can be determined based on the determined pixelwise location of the calibration object in the image, for example by reading the position values (e.g. [x, y, z]) corresponding to the determined colour channel values (e.g. [r, g, b]) in the composite depth image or point cloud. The image processing 402 thus yields a set of first object positions, e.g. [x, y, z] values, of the calibration object 242 in the workspace relative to the camera 216.

In certain cases, each (colour channel) image is processed to determine a centre-point of the calibration object. The determined pixelwise location of the calibration object in the image thus corresponds to the pixel location of the centre-point of the calibration object in the image. In such cases, the determined first object positions correspond to the centre-point of the calibration object 242. When a centre-point of the calibration object 242 is used for the calibration method 400, the orientation of the calibration object 242—e.g. its yaw position on the work surface—can be unknown. Thus, the method 400 can be agnostic to the orientation of the calibration object 242 in the workspace. In such cases, a calibration object 242 with an easily discernible centre-point, such as an AprilTag, may be used for the calibration. In certain examples, a set of at least four captured images, each corresponding to a unique robot pose, is used. For example, having at least four images, and thus points, can further constrain the point cloud registration process described later to provide a closed-form solution, e.g. even for instances where the yaw position of the calibration object 242 in the workspace is unknown.

The method 400 further involves obtaining 403 a set of second object positions of the calibration object 242 relative to the end effector 222 based on a determined, e.g. “known”, location of the calibration object 242 relative to the robotic manipulator 221. Each of the second object positions is obtained for a given configuration, e.g. waypoint, of the robotic manipulator 221.

The known location of the calibration object 242 relative to the robotic manipulator 221 is determined, for example, by positioning the end effector 222 at the location of the calibration object 242 in the workspace. That is, a known object position of the calibration object 242 relative to a given part of the robot 221, e.g. its base 232, can be calculated with the end effector 222 positioned at the calibration object in the workspace. For example, the robot control system's intrinsic knowledge of the position of the end effector 222 relative to other components of the robot 221, e.g. its base 232, is used to determine the known object position relative to the robot 221. In other words, the kinematic chain of the robot can be used (e.g. with a kinematics library) to map the end-effector position to a given reference frame, such that a connection (the robot structure itself in the present case) exists between the given reference frame and end-effector 222. The given reference frame may not always be the control frame utilised in the robot control system: for example, when controlling the robot in the joint space then the concept of a cartesian control frame does not exist.

In some examples, the calibration method 400 involves controlling the end effector 222 to grip an attachment, e.g. a pointer, and use it to touch the calibration object 242. For example, the end effector 222 is controlled to touch a particular point, e.g. the centre-point, of the calibration object 242 with the attachment. Thus, with the robot 221 in the configuration with the end effector 222 touching the calibration object 242 with the gripped attachment, the position of the end effector 222 relative to the robot coordinate system can be read as the position of the calibration object 242 relative to the robot coordinate system. Since the robot at all times knows its end-effector location compared to the robot coordinate system, the transformation between the coordinate systems of the end effector 222 and the robot 221, e.g. its base 232, is straightforward.

Thus, the set of second object positions can be determined using the known position of the calibration object relative to the robot 221, e.g. its base 232, and respective robot-hand transformations corresponding to the waypoints of the robot. For example, a given object position p^{e} of the calibration object 242 relative to the end effector 222 can be calculated as:

$${p}^{e} = {T}_{b}^{e} {p}^{b} = {( {T}_{e}^{b} )}^{- 1} {p}^{b} ;$$

where p^{b} is the measured position of the calibration object 242 relative to the base 232 of the robot 221 and T^{b}ₑ denotes the robot-hand transformation from the frame of reference of the end effector 222 to that of the base 232 of the robot 221.

The robot-hand transformation for a given configuration, e.g. at a given waypoint, of the robotic manipulator 221 can be deduced by forward kinematics. Forward kinematics is a known way of using the kinematic equations of the robot 221 to compute the position of its end-effector 222, e.g. from values for the joint parameters of the robot.

Table 1 shows example pseudocode for computing the position p^{e} of the calibration object 242 relative to the end effector (or “hand”) 222 of the robot 221, hand_P_point, given the configuration, q, of the robot 221 and the measured position p^{b} of the calibration object 242 relative to the base 232 of the robot 221, base_P_point.

TABLE 1

| | | |
|---|---|---|
| 1 | def | get_hand_P_point(q, base_P_point): |
| 2 | | base_T_hand = robot.forward_kinematics(q) |
| 3 | | hand_P_point = base_T_hand.inv( ) @ base_P_point |
| 4 | | return hand_P_point |

As shown in the pseudocode of Table 1, and consistent with the mathematical equations set out earlier, the transformation between the base 232 and hand 222 of the robot 221, base_T_hand, is determinable based on forward kinematics calculations in the given configuration, q, of the robot 221. The inverse of this transformation, base_T_hand.inv( ), is applied to the measured position of the calibration object 242 relative to the base 232 of the robot 221, base_P_point, to determine the location of the measured point relative to the hand 222 of the robot 221, hand_P_point.

Table 2 shows example pseudocode for collecting a dataset of (i) first object positions of the calibration object 242 relative to the camera 216, determined based on the image processing 402 described, and (ii) second object positions of the calibration object 242 relative to the end effector 222 determined based on the robot kinematics 403 as described.

TABLE 2

| | | |
|---|---|---|
| 1 | def | collect_data(robot, waypoints): |
| 2 | | dataset = [ ] |
| 3 | | for q in waypoints: |
| 4 | | robot.go_to(q) |
| 5 | | hand_P_point = get_hand_P_point( ) |
| 6 | | cam_P_point = detect_tag( ) |
| 7 | | dataset.append((hand_P_point, cam_P_point)) |
| 8 | | return dataset |

For each configuration, q, in the set of waypoints for calibrating the robot 221, the first object position, cam_P_point, of the calibration object 242 (e.g. tag) is determined using an object detection function for the tag, detect_tag( ), in the pseudocode of Table 2. The object detection function for detecting the calibration object 242 is performed on the image data captured at the given waypoint.

The corresponding second object position, hand_P_point, of the calibration object 242 is determined using the function get_hand_P_point( ), outlined in the pseudocode of Table 1 for applying a robot-hand transformation to the measured position of the calibration object relative to the robot 221, e.g. its base 232. The corresponding first and second object positions of the calibration object 242 for each waypoint are appended to the dataset, e.g. as a tuple (hand_P_point, cam_P_point).

The dataset of first object positions of the calibration object 242 relative to the camera 216 and second object positions of the calibration object 242 relative to the end effector 222 can be used to determine, as a calibration parameter, a hand-eye transformation comprising the transform between the end effector 222 and the camera 216 of the robot 221.

With the collected dataset of pairs of object positions, (hand_P_point, cam_P_point), determining the hand-eye transformation can be treated as a point-cloud registration (or “point-set registration”) problem in which a spatial transformation is found which aligns two point clouds (or “point sets”). A first point-cloud is formed from the first set of first object positions 371 relative to the camera 216 and a second point-cloud is formed from the second set of second object positions 372 relative to the end effector 222 of the robot 221. The calibration method 400 involves performing the point-cloud registration 404, based on the two point clouds, to determine the hand-eye transformation. This type of hand-eye calibration is known as “eye-in-hand” since the camera 216 is mounted on the robot arm 220 itself, as opposed to “eye-to-hand” in which a camera is mounted stationary next to a robot. In the present eye-in-hand case, the transformation from the robot end-effector (the robot tool point) to the camera is sought. Since the robot at all times knows its end-effector location compared to the robot coordinate system, the transformation from the end effector to the robot, e.g. its base, can be calculated.

FIGS. 3A and 3B schematically depict the first set of first object positions 371 relative to the camera 216 and the second set of second object positions 372 relative to the end effector 222. The dashed arrows for the first object positions 371 represent the detections of the calibration object 242 relative to the camera 216. The solid arrows for the second object positions 372 relative to the end effector 222 represent the computations of the measured object position of the calibration object 242 relative to the robot 221, e.g. its base 232. By registering these detections together, as shown in FIG. 3B by the two sets of object positions 371, 372 having been moved so that they (the squares and respective circles in each set) coincide, the sought hand-eye calibration parameter denoted by the arrow 250 can be calculated. The hand-eye calibration parameter being calculated is the transform between the respective frames of reference of the camera 216 and the end effector 222, in other words the pose of the camera 216 with respect to the wrist/hand 222 of the robot.

Mathematically, the relationship between the corresponding points in each pair of object positions

$$( {p}_{i}^{c} , {p}_{i}^{e} )$$

at each waypoint i is given by:

$${p}_{i}^{e} = {T}_{c}^{e} {p}_{i}^{c} ;$$

$$or$$

$${p}_{i}^{c} = {( {T}_{c}^{e} )}^{- 1} {p}_{i}^{e} ;$$

where

$${T}_{c}^{e}$$

is the hand-eye transformation to be calculated, e.g. optimised, by registering the first set of points

$${p}_{i}^{c}$$

with the second set of points

$${p}_{i}^{e} .$$

In FIGS. 3A and 3B, the camera 216 is shown independently of the robotic manipulator 221 to make the point cloud registration and transformation concepts easier to visualise. In reality, the camera 216 is mounted to the robotic manipulator 221, as described in examples herein.

In examples, the point-cloud registration 404 is done based on feature matching. For example, the calibration method 400 involves assigning to each of the first and second object positions a corresponding independent feature vector. The point-cloud registration 404 can then be performed based on feature matching using the independent feature vectors. As an example, one-hot vectors of a dimensionality matching the number of waypoints for the robot 221 can be used to indicate that each feature is independent of the others. In FIG. 3A, for example, the leftmost point in each of the sets of object positions 371, 372 is assigned the vector [1, 0, 0, 0], the next point to the right [0, 1, 0, 0] and then [0, 0, 1, 0] and [0, 0, 0, 1] for the next two points respectively. Thus, the object positions in each pair

$$( {p}_{i}^{c} , {p}_{i}^{e} )$$

—determined at the same waypoint i of the robot 221—are assigned the same feature vector so that these independent features can be matched during the point-cloud registration 404. Other variations of point-cloud registration can be used in the calibration method 400, for example registration based on correspondence. In this case, indices of the corresponding point or feature arrays are used with the first and second (e.g. “source” and “target”) point clouds to register them.

The output of the point-cloud registration 404, and the calibration method 400 as a whole, is the determined hand-eye transformation. In examples, the hand-eye transformation is stored, e.g. in computer memory, for transforming coordinates of a detected object in a first coordinate system of the camera 216 to a second coordinate system of the robotic manipulator 221 or end effector 222. The detected object could be any type of object that an object detection system comprising the camera 216 is trained to detect. For example, the object could be one which the robotic manipulator 221 is to manipulate as part of its operation. With the stored hand-eye transformation

$${T}_{c}^{e} ,$$

a detected object location p^{c} in the coordinate system of the camera 216 can be transformed to an object location p^{e} in the coordinate system of the end effector 222 per the equation above. Since the robot 221 at all times knows its end-effector location compared to the robot coordinate system, e.g. the base 232 coordinate system, the object location p^{e} in the coordinate system of the end effector 222 can be transformed to any coordinate system of the robot 221. Thus, the object detection system can detect an object using the camera 216 mounted on the robot 221, and the position of the object relative to the camera 216 can be transformed into coordinates intuitive to the robot 221, i.e. in its reference frame, which can be passed directly to a end effector 222 to manipulate the object.

The calibration method 400 can be implemented by a control system or controller for the robotic manipulator, e.g. the control system or controller of the robotic system 100 previously described. For example, the control system or controller includes one or more processors to carry out the method 400 in accordance with instructions, e.g. computer program code, stored on a computer-readable data carrier or storage medium.

Overall, the present system and methods leverage the knowledge of where the calibration object, e.g. fiducial tag, is installed in the workspace—which can be measured directly by the robot—to significantly simplify the hand-eye calibration problem. The problem of hand-eye calibration reduces into a problem of point-cloud registration, which will always have a global solution, and can be implemented using a point cloud registration solver.

As described in earlier examples, a robotic manipulator 221 with a mounted camera 216 calibrated according to the present methods 400 can be deployed in an automated storage and retrieval system (ASRS), e.g. at a picking station thereof, to pick and place items between containers.

The one or more containers at a picking station of the ASRS may be considered as being storage containers or delivery containers. A storage container is a container which remains within the ASRS and holds “eaches” of products which can be transferred from the storage container to a delivery container. A delivery container is a container that is introduced into the ASRS when empty and that has a number of different products loaded into it. A delivery container may comprise one or more bags or cartons into which products may be loaded. A delivery container may be substantially the same size as a storage container. Alternatively, a delivery container may be slightly smaller than a storage container such that a delivery container may be nested within a storage container. The calibrated robotic manipulator 221 can therefore be used to pick an item from one container, e.g. a storage container, and place the item into another container, e.g. a delivery container, at a picking station. The picking station may thus have two sections: one section for the storage container and one for the delivery container. The arrangement of the picking station, e.g. the sections thereof, can be varied and selected by the skilled person. For example, the two sections may be arranged on two sides of an area or with one section above or below the other. In some cases, the picking station is located away from the storage locations of the containers in the ASRS, e.g. away from the storage grid in a grid-based ASRS. The load handling devices may therefore deliver and collect the containers to/from one or more ports of the ASRS which are linked to the picking station, e.g. by chutes. In other instances, the picking station is located to interact directly with a subset of storage locations in the ASRS, e.g. to pick and place items between containers located at the subset of storage locations. For example, in the case of a grid-based ASRS, the picking station may be located on the grid of the ASRS.

The robotic manipulator 221 may comprise one or more end effectors 222. For example, the robotic manipulator 221 may comprise more than one different type of end effector. In some examples, the robotic manipulator 221 may be configured to exchange a first end effector for a second effector. In some cases, the robot controller may send instructions to the robotic manipulator 221 as to which end effector 222 to use for each different object or product (or stock keeping unit, “SKU”) being manipulated, e.g. packed. Alternatively, the robotic manipulator 221 may determine which end effector to use based on the weight, size, shape etc. of a product. Previous successes and/or failures to grasp and move an item may be used to update the selection of an end effector for a particular SKU. This information may be fed back to the controller so that the success/failure information can be stored and shared between different picking/packing stations.

Similarly, the robotic manipulator 221 may be able to change end effectors 222. For example, the picking/packing station may comprise a storage area which can receive one or more end effectors. The robotic manipulator 221 may be configured such that an end effector in use can be removed from the robotic arm 220 and placed into the end effector storage area. A further end effector may then be removably attached to the robotic arm 220 such that it can be used for subsequent picking/packing operations. The end effector may be selected in accordance with planned picking/packing operations.

The above examples are to be understood as illustrative examples. Further examples are envisaged. For instance, the eye-hand calibrated camera per the described examples can be used to calibrate any other camera in the scene. For example, with a static camera in the workspace it is possible to obtain a pose of an object, as seen by the static camera, in the base frame of the robot. The static camera may be mounted above a container of items in the described ASRS implementation, with the object being an item stored in the container for picking by the robot comprising the mounted camera, for example. Calibrating such a setup involves, according to the envisaged examples, utilising a calibration object, e.g. fiducial marker such as an ARTag, that is visible to both the robot-mounted camera and the static camera. The pose of the calibration object in a reference frame of the robot, e.g. the base of the robot, can be determined based on the hand-eye calibration, and a further pose of the calibration object is detectable in the frame of the static camera. Thus, as these two poses correspond one-to-one, the pose of the static camera in the frame of the robot can be determined.

Furthermore, in some of the foregone examples, the camera is described as being wrist-mounted, i.e. mounted to the robotic manipulator at the end-effector. However, the camera being calibrated can be mounted anywhere on the robotic manipulator. Although the term of art “hand-eye calibration” has been used, it is not intended to limit the mounting location of the camera. For example, the camera can be mounted at a different joint, e.g. the “shoulder” instead of the “wrist”, of the robot and the same method can be used for the camera calibration (which might be termed more precisely as a “shoulder-eye calibration” in this instance).

It is also to be understood that any feature described in relation to any one example may be used alone, or in combination with other features described, and may also be used in combination with one or more features of any other of the examples, or any combination of any other of the examples. Furthermore, equivalents and modifications not described above may also be employed without departing from the scope of the accompanying claims.

1. A method of calibrating a camera mounted on a robotic manipulator comprising an end effector, the method comprising:
obtaining a plurality of images of a single calibration object installed at a location in a workspace of the robotic manipulator, wherein the images are captured by the camera at different respective configurations of the robotic manipulator;
processing the images to obtain respective first object positions of the calibration object relative to the camera;
obtaining respective second object positions of the calibration object relative to the end effector based on a determined location of the calibration object relative to the robotic manipulator; and
performing point-cloud registration based on a first point cloud comprising the first object positions and a second point cloud comprising the second object positions to determine a hand-eye transformation.

2. The method according to claim 1, wherein obtaining the respective second object positions comprises:
positioning the end effector at the location of the calibration object in the workspace to determine a third object position relative to the robotic manipulator; and
determining the second object positions based on the third object position and respective robot-hand transformations corresponding to the respective configurations of the robotic manipulator.

3. The method according to claim 1, wherein the plurality of images comprises a set of at least four images.

4. The method according to claim 1, wherein processing the images comprises performing at least one of line detection, rectangle detection, or object detection to detect the calibration object in each of the images.

5. The method according to claim 4, wherein processing the images comprises performing position estimation based on the detected calibration object in each of the images to determine the respective first object positions.

6. The method according to claim 1, wherein the single calibration object is installed at an unknown orientation in the workspace.

7. The method according to claim 1, wherein performing the point-cloud registration comprises assigning to each of the first object positions a corresponding independent feature vector.

8. The method according to claim 7, wherein performing the point-cloud registration comprises performing point-cloud registration based on feature matching using the independent feature vectors.

9. The method according to claim 1, wherein the calibration object comprises a fiducial marker.

10. The method according to claim 9, wherein the fiducial marker comprises one of an: ARTag, AprilTag, ArUco or STag marker.

11. The method according to claim 1, wherein the first and second object positions comprise respective positions of a centre-point of the calibration object.

12. The method according to claim 1, comprising storing the hand-eye transformation for transforming coordinates of a detected object in a first coordinate system of the camera to a second coordinate system of the robotic manipulator or end effector.

13. The method according to claim 1, comprising:
obtaining and processing an image of the single calibration object, captured by a static camera in the workspace, to determine a first pose of the calibration object relative to the static camera;
determining a second pose of the calibration object in a reference frame of the robotic manipulator based on another image of the single calibration object, captured by the camera mounted on the robotic manipulator, and the hand-eye transformation; and
determining a pose of the static camera, in the reference frame of the robotic manipulator, based on the first and second poses of the calibration object.

14. A computer program comprising instructions which, when the program is executed by a computer, cause the computer to carry out the method of claim 1.

15. A computer-readable data carrier having stored thereon the computer program of claim 14.

16. A controller for a robotic manipulator, wherein the controller is configured to perform the method of claim 1.

17. A system comprising:
a robotic manipulator having an end effector and a mounted camera;
a single calibration object installed at a location in a workspace of the robotic manipulator; and
a controller configured to:
obtain and process a plurality of images of the single calibration object, captured by the mounted camera at different respective configurations of the robotic manipulator, to obtain respective first object positions of the calibration object relative to the camera;
obtain respective second object positions of the calibration object relative to the end effector based on a determined location of the calibration object relative to the robotic manipulator; and
perform point-cloud registration based on a first point cloud comprising the first object positions and a second point cloud comprising the second object positions to determine a hand-eye transformation.

18. The system according to claim 17, comprising a static camera positioned in the workspace, wherein the controller is configured to:
obtain and process an image of the single calibration object, captured by the static camera, to determine a first pose of the calibration object relative to the static camera;
determine a second pose of the calibration object in a reference frame of the robotic manipulator based on another image of the single calibration object, captured by the mounted camera, and the hand-eye transformation; and
determine a pose of the static camera, in the reference frame of the robotic manipulator, based on the first and second poses of the calibration object.
